(19) United States
(12) Patent Application Publication
(10) Pub. No.: US 2026/0342843 A1
(43) Pub. Date: Oct. 29, 2026

(54) System and Method for Dynamic Storyboarding on a Network with a Visual Representation

(71) Applicant: Aaron Scott Boteler, Baltimore, MD (US)

(72) Inventor: Aaron Scott Boteler, Baltimore, MD (US)

(21) Appl. No.: 19/707,308

(22) Filed: Jun. 14, 2026

Related U.S. Application Data
(60) Provisional application No. 62/823,855, filed on Mar. 26, 2019.

(51) Int. Cl. H04L 9/40

(52) U.S. Cl. CPC H04L 63/1433

(57) ABSTRACT

A system and method for Dynamic Storyboarding on a Network with a Visual Representation that supports the creation of multiple separate themed storyline sets simultaneously. A themed storyline set represents a sequence of events in time with the events selected by the user, i.e. the theme, where each entry contains a time-stamp, visual effect, end-node identifier, and source information from the ingested data. A theme in a storyline set describes the targeted purpose of the sequence of events for event replay and live monitoring for asset health and security purposes.

### CROSS REFERENCE TO RELATED APPLICATION

The present application claims the benefits of and priority, under 35 U.S.C. § 119(e), to U.S. Provisional Application Ser. No. 62/823,855, filed on Jun. 14, 2025 entitled “SYSTEM AND METHOD FOR DYNAMIC STORYBOARDING ON A NETWORK WITH A VISUAL REPRESENTATION.” The entire disclosure of the application listed above is hereby incorporated by reference, in its entirety, for all that it teaches and for all purposes.

### STATEMENT REGARDING FEDERALLY SPONSORED RESEARCH OR DEVELOPMENT

Work for hire: no

Work under US Government contracts: no

Work under Foreign Government contracts: no

Secret: no

### SUMMARY OF THE INVENTION

The present invention refers to a system and method for Dynamic Storyboarding on a Network with a Visual Representation that supports the creation of multiple separate themed storyline sets simultaneously. A themed storyline set represents a sequence of events in time with the events selected by the user, i.e. the theme, where each entry contains a time-stamp, visual effect, end-node identifier, and source information from the ingested data. A theme in a storyline set describes the targeted purpose of the sequence of events for event replay and live monitoring and represents the rules and filters placed on the data to focus the analysis of the network, such as, but not limited to, focusing on tcpflooding and encrypted communications across a network, https server load over time, or manufacturing line telemetry faults. The Dynamic Storyboarding invention provides a visual representation of the network for each themed storyline and can run multiple themed storylines. This sequence of events for each themed storyline are connected in chronological order and have timeline controls. The timeline controls allow the Dynamic Storyboarding invention to provide a user with the ability to flip pages through time, including forward or back, run an animation, and monitor networks near real time. The visual representation of the network with the underlying data provided by the Dynamic Storyboarding provides the user with an understanding of the health and security posture of a network and allows them to examine and diagnose issues or potential issues with the network.

The ingested data is from the data processing pipeline that takes raw data, including, but not limited to, time-stamped logs, alerts, packet captures, environmental feeds, telemetry measurements, sensor feeds, and so on through a domain-specific data processor that converts the pertinent information into a normalized data structure, referred as ingested data, used by this said invention.

The flexibility of the Dynamic Storyboarding covers a wide range of networks that span cloud-based, information technology (“IT”), operational technology (“OT”), or some mixture of the three categories. The invention provides a wide range of uses, including, but not limited to network intrusion forensics, network login behaviors, IT server operational health, OT operational health monitoring, security and network operations center, OT manufacturing line monitoring, building HVAC monitoring, and energy substation monitoring. Furthermore, the invention supports past event replay and for near real-time monitoring for current operational picture where the focus is based on the applied themed storyline set.

### REFERENCES

U.S. Pat. No. 11,902,318 B2 Feb. 13, 2024 Rivera et al.

### FIELD OF THE INVENTION

This invention relates to general cyber security including, but not limited to, incident handling, forensics, and asset health and security behavioral monitoring. It applies to multiple market categories, including, among others, cyber security and critical infrastructure health and security monitoring, including but not limited to data centers, security operation centers, network operation centers, home networking, building HVACs, energy substations, water municipalities, and energy substations.

### BACKGROUND OF THE INVENTION

As system networks have expanded to include virtual, cloud, physical, and OT components, developing computer software and methods to map a network, to monitor its health/status, and examine past network incidents have become a complicated process. A myriad of different activities and tools may be included in the process, including but not limited to Network Mapping, Data Repositories, Traffic Sensors, Compliance Monitoring, Telemetry readings, Software agents, Incident sensors, and Incident management. When a network incident occurs, including but not limited to a cyber attack, software failure, hardware failure, human error, or environmental effects, the operators need to determine a story of events of what happened and the impact of the event.

Currently, when an incident occurs, an operator manually reviews data related to the incident, such as data repositories, traffic sensors, activity logs, and incident sensor outputs. From the manual review, the operator attempts to determine the timeline of events surrounding the incident to determine, among other things, what was the incident, what led to the incident, where did it occur on the network, what happened during the incident, what happened after the incident, and what impact did it have on other parts of the network. The current approach has several failings, including, reliance on operators with senior level expertise, time intensive analysis, and lack of ability to take into account near real time events. The current approach describes what happened through static maps and data tables. The lack of a dynamic visual picture of what happened handicaps the ability to process the information.

There is a need in the market for computer software and processes to automate storyboarding and provide a dynamic visual representation of the timeline of events, i.e. Dynamic Storyboarding.

Based on a prior art search, the applicant identified a system disclosed in U.S. Pat. No. 11,902,318 B2 Feb. 13, 2024 Rivera et al., which is titled “Network visualization, intrusion detection, and network healing.” That patent application has substantial differences from the current Dynamic Storyboarding invention. The Rivera patent is limited to power system networks, limited to anomaly detection on supervisory control and data acquisition (SCADA) network data, and lacks supporting many themed storyline sets for targeted understanding in the IT space and others.

The present Dynamic Storyboarding invention has methods that receive and process raw data from a variety of sources and is not limited to OT power systems. The Dynamic Storyboarding invention contains a matching data processing plugin that converts the raw data into a normalized data structure. The normalized data structure next is applied against pre-configured themed storyline sets, not limited to just anomaly incidents, to produce health and security chronological order sequences. These themed storyline sets enable the user to replay and monitor cloud, IT, and OT networks operations for a particular targeted topic.

The Dynamic Storyboarding invention would solve many of the problems stated early and others. It allows monitoring for the near real time events in the network, for analysis of current event trends, for less senior operators to conduct the review, and a visual representation of the events to enhance the ability to tell the story and diagnose any issues.

### BRIEF DESCRIPTION OF THE DRAWINGS

Many aspects of the disclosure can be better understood with reference to the following diagrams.

FIG. 1. is a block diagram illustrating a computing environment and system architecture for implementing the Dynamic Storyboarding System and Method, in accordance with one embodiment of the present invention.

FIG. 2. is a use case diagram illustrating a real-world implementation environment of the Dynamic Storyboard method for IT security monitoring visualization.

FIG. 3. is a use case diagram illustrating a real-world implementation environment of the Dynamic Storyboard method for OT security monitoring visualization.

### DETAILED DESCRIPTION OF THE INVENTION

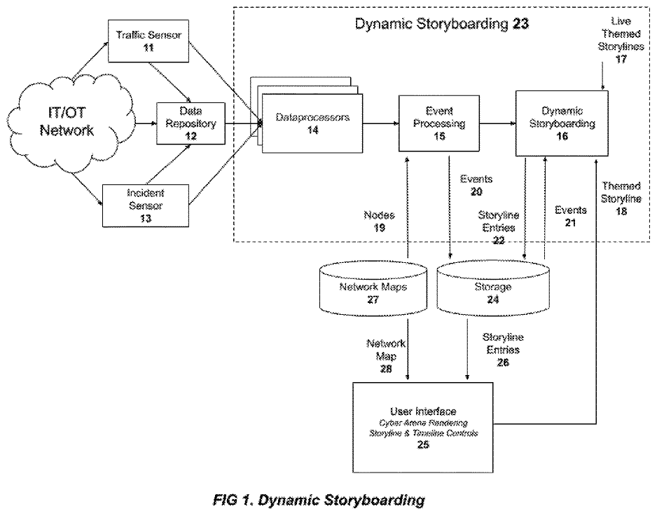

Referring now to FIG. 1., Dynamic Storyboarding, the traffic sensor 11, data repository 12, and incident sensor 13 from third-party software and hardware appliances generate time-stamped events from, among others, traffic flows, firewalls, RTU logs/events, enterprise security appliances, software/hardware agent logs, and/or other appliance logs. The time-stamped events are processed in the Dynamic Storyboarding 23.

For purposes of illustration only, a typical source of events is a firewall device. A firewall device monitors traffic on a network pipe so when the device detects tcpflooding, encrypted SSL traffic, spoofed-IPs, DoS attacks, and others an event is generated which is forwarded to the Dataprocessors 14. A Dataprocessor is used to map the tool-specific data source into a normalized format used in the ingestion process.

The normalized format is sent to the Event Processing 15. The Event Processing uses node identifiable information to locate the node(s) of interest from the Network Map 27. The normalized format includes the description and state variables provided in a tree data structure which is the event output. Using the identified Node(s), an event is created and tagged with those Nodes 19. All created Events 20 are stored in Storage 24.

A Storyline represents a particular theme to the storyboard. The ability to apply a themed storyline onto the Network Map enables the operator to filter through the vast troves of data to focus on particular categories of incidents. You can have storylines focused on probing activity, hardware CPU metrics leading to a system failure, environmental impact on systems, login failures, and more. This approach works with past and current activity. Multiple themed storylines are supported and a themed storyline can be marked as live. If Live Themed Storylines 17 are configured, any newly created events from 15 are sent to the Dynamic Storyboarding 16.

The Dynamic Storyboarding 16 applies the inputted Storylines from 17 or 18, to the events 21 from the recent ingestion or from a previously stored time-range. Each themed storyline has a unique set of rules and a time-range. If it is a live themed storyline, the time-range automatically updates to near real time. The rules are set up to apply string or numeric-based tests against the event.

Each storyline rule contains a path to an entry in the tree data structure, a hit test mode, a value, and a visual effect to apply. The mode sets if the hit test is string-based or numeric-based. The string based expression supports string containment and other regular expressions, for example identifying a “tcpflood” in the description. The numeric based expressions support equals, greater than, less than, or within a range expressions, for example identifying when the CPU Utilization is greater than 90%.

When a storyline's rule hits, a storyline entry 22 is created with the full event data and any applied visual effect, including, among others, color highlighting, model adjustment or associated edge adjustments. The storyline entries are stored in Storage 24.

The visual presentation of the Themed Storyline overlaid on the Network Map occurs in the User Interface 25. The user selects a Network Map 28 from the Network Maps 27 along with a particular themed storyline. Using the timeline controls, the User Interface 25 will fetch Storyline Entries 26 that match a set of filters.

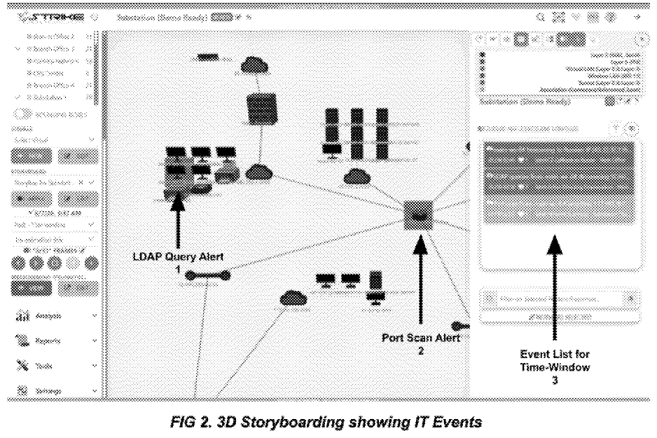

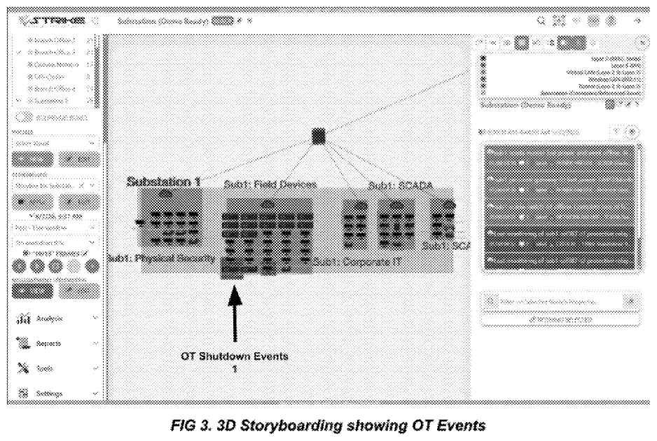

The Dynamic Storyboarding presentation requires a visualization engine and framework capable of presenting the Network Map along with dynamic and multivariate visual effects based on the storyline events in the active time-window. The invention's current visualization engine embodiment is depicted in FIG. 2. and FIG. 3., in which are screenshots of the dynamic storyboarding in action, according to some embodiments of the present disclosure. The current visualization engine embodiment is a Web-based Application using a WebGL framework that scales from very large enterprise networks with 20,000 plus devices to small manufacturing ranges with under a hundred devices all in an 3D immersive rendering of the Cyber arena.

FIG. 2. depicts the firewall traffic alerts LDAP Query (1) and Port Scan (2) as colored planes behind the targeted devices. These alerts were sourced from an external firewall device that was ingested, normalized, and filter-out by using rules defined in the storyline selected.

FIG. 3. depicts the OT sensor alerts stored in a Security Information and Event Management (SIEM) system for device operational health. The OT Shutdown Events (1) is visualized as colored planes behind the targeted devices. These alerts were sourced by a SIEM system that was ingested, normalized, and filter-out by using rules defined in the storyline selected.

The timeline controls, as depicted in FIG. 2 And FIG. 3., enable stepping forward and backward, playing the timeline, or near real time monitoring by varying the time-window in the filter parameter to fetch the storyline entries. In addition, the timeline controls allow the user to pivot the view to see the entire timeline for a particular node or set of nodes. By varying the timeline, an animation may be produced on the chosen storyline.

The functional block diagram in FIG. 1. is representative of exemplary systems, environments, and methodologies for performance of the novel aspects of this disclosure. The block diagram depicts the flow of data and applied logic required to achieve these themed storyline event streams required for health and security dynamic visualizations.

What is claimed is

1. A dynamic storyboarding method for cyber-security and operational health monitoring of networks, such as Cloud, IT, and OT, comprising:
receiving entry point for raw data that includes but not limited to firewall logs, live packet captures, external sensor feeds, Security Information and Event Management (SIEM) outputs, SNMP faults, and telemetry captures/faults that are time-stamped and contain end-node identifiable keys; and
processing by domain-specific data processor based on the raw data type to generate a normalized data structure (ingested data); and
processing the normalized data structure in the event processing which cross-references with the network map to produce an event output; and
transmitting the event output to the dynamic storyboarding system that processes the event output against the set of rules created by the user to create the themed storyline sets;
processes the themed storyline sets to add visual effects on the relevant end-nodes along with the underlying data.

2. The dynamic storyboarding method for cyber-security and operational health of claim 1, wherein how to determine the visual effect to apply from the event output comprises:
testing every storyline set rule against the event output using some combination of path-based, regular expressions, and/or numeric expressions on the key and/or value portions as specified in the rule; and
creating a storyline set entry for every rule hit which also sets the visual effect to be applied at that specific time.

3. The dynamic storyboarding method for cyber-security and operational health of claim 1, wherein how the timeline controls manipulate the visualization effects comprises:
specifying what themed storyline set to overlay on the displayed network map; and
fetches the storyline set entries to reflect the number of entries for a particular time-set configured by the user, i.e. time-slice; and
providing time-slice forward and backward stepping and automated stepping, referred as the event replay; and
animating the storyline's visual effects on the network map.

4. The dynamic storyboarding method for cyber-security and operational health of claim 1, wherein for IT security monitoring comprising:
receiving IT security information including, but not limited to, firewall logs, tcpfloods, encrypted SSL communications, pings, login logs from a SIEM; and
creating a storyline set focusing on IT security including, but not limited to, highlighting network probing, unusual encrypted communications, and login failures for event replay; and
fetching IT security storyline set entries to reflect the number of entries for a particular time-set configured by the user; and
providing the event replay of the IT security storyline set; and
animating the IT security storyline set on the network map.

5. The dynamic storyboarding method for cyber-security and operational health of claim 1, wherein for IT asset health monitoring comprising:
receiving IT telemetry including, but not limited to, CPU utilization, network ingress, server connections, flow metrics; and
creating a storyline set focusing on IT asset health including, but not limited to, highlighting healthy, warning, abnormal, and failure conditions for event replay; and
fetching IT asset health storyline set entries to reflect the number of entries for a particular time-set configured by the user; and
providing the event replay of the IT asset health storyline set; and
animating the IT asset health storyline set on the network map.

6. The dynamic storyboarding method for cyber-security and operational health of claim 1, wherein for OT security monitoring comprising:
receiving OT telemetry and alerts including, but not limited to, unauthorized initiators, write-point
violations, out-of-band violations, login alerts; and
creating a storyline set focusing on OT security including, but not limited to, highlighting unauthorized initiators, write-point faults, and login alerts for event replay; and
fetching OT security storyline set entries to reflect the number of entries for a particular time-set configured by the user; and
providing the event replay of the OT security storyline set; and
animating the OT security storyline set on the network map.

7. The dynamic storyboarding method for cyber-security and operational health of claim 1, wherein for OT asset health monitoring comprising:
receiving OT telemetry and alerts including, but not limited to, outside environment readings, device temperature readings, device energy consumed, write-point violations; and
creating a storyline set focusing on OT asset health including, but not limited to, highlighting healthy, warning, abnormal, and failure conditions for event replay; and
fetching OT asset health storyline set entries to reflect the number of entries for a particular time-set configured by the user; and
providing the event replay of the OT asset health storyline set; and
animating the OT asset health storyline set on the network map.
